(19) United States
(12) Patent Application Publication
(10) Pub. No.: US 2017/0350133 A1
(43) Pub. Date: Dec. 7, 2017

(54) LARGE-SIZED EXTERIOR AWNING DEVICE FOR HIGH-RISE BUILDING

(71) Applicant: Kiyoung CHUNG, (KR)

(72) Inventor: Kiyoung CHUNG, (KR)

(21) Appl. No.: 15/540,562

(22) PCT Filed: Sep. 25, 2015
(86) PCT No.: PCT/KR2015/010208

§ 371 Date: Jun. 28, 2017

(30) Foreign Application Priority Data
Dec. 30, 2014 (KR) 10-2014-0193320

(51) Int. Cl. E04F 10/02; E06B 9/24

(52) U.S. Cl. CPC E04F 10/02; E06B 9/24

(57) ABSTRACT

The present invention relates to a large-sized external awning system which includes a winch provided at an upper story, a rooftop or the ground of a high-rise building, two guide wires spaced apart at a predetermined distance to be provided in parallel, a plurality of raising and lowering rods provided with wire-passing holes through which the guide wires pass such that the raising and lowering rods are raised and lowered along the guide wires, and an awning coupled to the raising and lowering rods and unfolded so as to block the sunlight when the raising and lowering rods are spaced apart from each other.

### TECHNICAL FIELD

The present invention relates to a large-sized external awning system for a high-rise building, which is configured to improve the effect of blocking solar heat, while being installed in the outside of a building to effectively block the sunlight (heat) from entering inside of the building, where the system is applicable for large scale high-rise buildings.

### BACKGROUND

As the urbanization progresses, a design of the building has also changed in a way to alleviate a visual closure of the building. In addition, as a method for constructing a building more quickly, the use ratio of glass materials is increasing as an open and economical construction method rather than a typical closed-material form. Furthermore, a large-sized glass building having a curtain wall type in which a front exterior wall is made of glass becomes popular.

However, a problem for the energy efficiency of the building due to energy leakage, which is a disadvantage of the glass materials, has become a serious social and economic problem. Especially, the increase of the internal temperature of the glass building due to excessively direct sunlight in summer dramatically increases the cost of air-conditioning of the building, and is the main cause of power overloading of the whole country in summer. In addition, the excessive inflow of ultraviolet rays causes many problems in human health, and visual disturbance due to direct sunlight reflection in the glass building is emerging as a serious problem of urban pollution.

Conventionally, in order to block the inflow of solar heat, an approach for providing an awning inside of the building such as using curtains or blinds inside of the buildings, or attaching a color (shading) film to the glass is used. In recent years, it is being tried to employ low energy glasses or to insert ultra-small blinds between double/triple windows.

However, regardless of a type of internal awning method, the solar heat is already entered the inside of the building, and most of the solar heat energy stays inside of the building so the heat blocking effect is insignificant in a blind/curtain manner. In addition, the low energy glass and the like adopt the principle of the time delay of solar heat transfer, and thus, the solar heat blocking effect due to the awning is not great, and also, there is a disadvantage that installation cost is high.

In addition, there is a manner of installing an external blind or an awning, or a louver for the manner of providing an awning structure outside the building. However, there is a problem that the installation is limited due to the influence of the wind in the buildings of five stories or more, and there are problems of a cost and damage (change) to the exterior wall of the building permanently once installed. In particular, the louver costs more, and has to be installed permanently on the exterior wall of the building so there are many difficulties in securing the view and changing the appearance of the building, thereby being adopted restrictively.

### DISCLOSURE

### Technical Problem

The present invention is an innovative improvement of non-economic feasibility and the limitation of the installation in an existing manner for an external awning system in which the solar heat blocking effect in summer is higher (than the internal awning system), and the objects of the present invention are as follows.

First, it is an object of the present invention to provide a large-sized external awning system for a high-rise building, which can be provided in the large-sized high-rise building (for commercial, residential) largely affected by the wind.

Second, it is another object of the present invention to provide a large-sized external awning system for the high-rise building, which can be installed and removed as needed and does not affect the appearance of the building.

Third, it is another object of the present invention to provide a large-sized external awning system for the high-rise building, which can reduce the heating energy by allowing sunlight to flow inside to the maximum in the winter.

Fourth, it is another object of the present invention to provide a large-sized external awning system for the high-rise building, which can be used universally in economical installation cost.

### Technical Solution

The present invention comprises: a winch 100 provided at an upper story, a rooftop or the ground of a high-rise building, and releasing or winding up a cable 110; two guide wires 200 connected to a lower story or the ground of the high-rise building from the upper story or the rooftop of the high-rise building, and spaced apart at a predetermined distance to be provided in parallel; a plurality of raising and lowering rods 300 provided in the horizontal direction, and provided with, at each of the left and right end portions thereof, wire-passing holes 310 through which the guide wires 200 pass such that the raising and lowering rods are raised and lowered along the guide wires 200; and an awning 400 coupled to the raising and lowering rods 300, and unfolded so as to block the sunlight when the raising and lowering rods 300 are spaced apart from each other while being raised or lowered, wherein the cable 110 of the winch 100 winds up or release the uppermost or lowermost raising and lowering rod 300 among the raising and lowering rods 300, and when the cable 110 of the winch 100 winds up the lowermost raising and lowering rod 300 among the raising and lowering rods 300, the uppermost raising and lowering rod 300 is fixed to the guide wire 200 at the upper story of the high-rise building.

### Advantageous Effects

Technical effects according to the present invention are as follows.

First, an external awning system can be provided in a high-rise large building (for commercial, residential), which has been virtually impossible due to the influence of the wind.

Second, the system can be provided without permanently and largely affecting the original appearance of the building and the overall city aesthetic.

Third, the glare pollution of the city center can be eliminated due to the direct light reflection of the glass building in a broad day.

Fourth, depending on the material of an awning, the system can not only take into consideration some views at the same time as an awning, but also be used for the screen by the beam project at night.

Fifth, easy control and management of the entire system can improve the efficiency of building energy management, and saving energy costs alone can get investment costs for the awning back early.

Sixth, the system can allow for various designs to be used to create fresh city scenery in summer, and company logos and pitches can be attached to the awning for public promotion.

### BRIEF DESCRIPTION OF THE DRAWINGS

FIG. 1 is a view illustrating a winch 100 installed on the ground.

FIG. 2 is a view illustrating a winch 100 provided on a rooftop of a high-rise building.

FIG. 3 is a view illustrating an embodiment of an awning 400.

FIG. 4 is a view illustrating another embodiment of an awning 400.

FIG. 5 is a view illustrating another embodiment of an awning 400.

FIG. 6 is a view illustrating an installation structure of a panel holder 450 as an embodiment according to FIG. 5.

### BEST MODE

Hereinafter, specific embodiments of the present invention will be described in more detail with reference to the accompanying drawings.

The present invention relates to a large-sized external awning system for a high-rise building, and particularly, a large-sized awning system which can maximize the awning effect by being provided in the outside of a building and blocking the sunlight (heat) from entering inside of the building in summer, and also is capable of applying to a high-rise large-sized building.

A winch 100 is provided on an upper story, a rooftop or a ground of a high-rise building and serves to release or wind up a cable 110.

The winch 100 corresponds to a kind of cable reel, and it can be selected among various kinds and specifications of products in consideration of conditions such as installation space, a surrounding environment or the like.

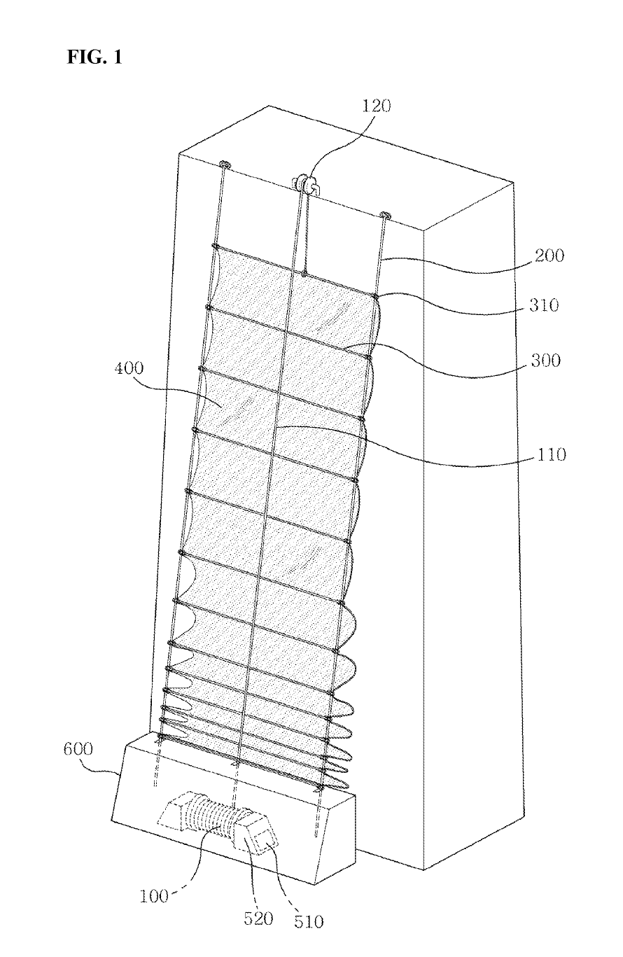

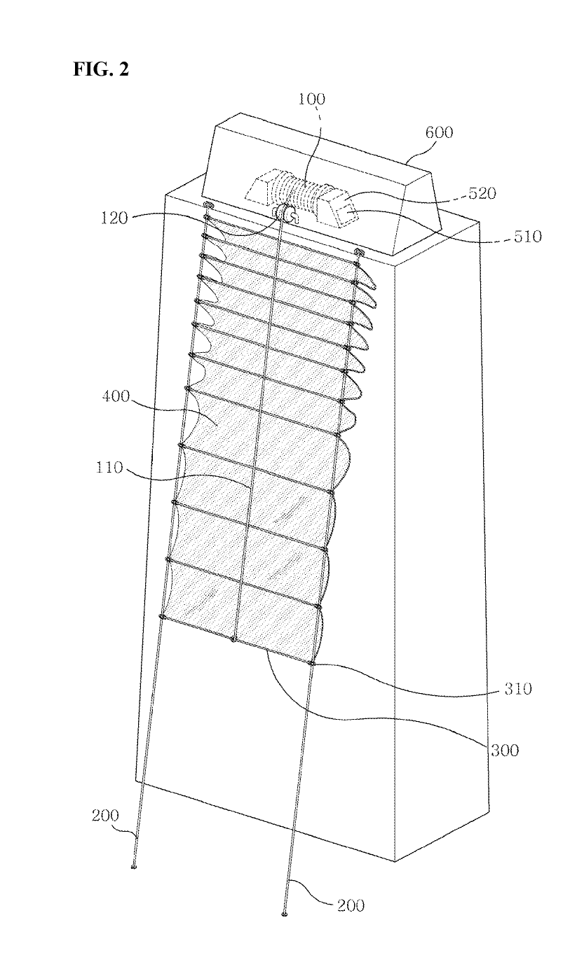

The winch 100 may be provided on the ground as shown in FIG. 1, and may be provided on the rooftop of the high-rise building as shown in FIG. 2. Although not shown in the accompanying drawings, it is also possible to provide a suitable installation space in the upper story of the high-rise building and install the winch 100.

Guide wires 200 is connected to a lower story or the ground of the high-rise building from the upper story or the rooftop of the high-rise building, and two guide wires 200 are provided spaced apart at a predetermined distance to be provided in parallel and serves as a guide for raising and lowering rods 300. The guide wires 200 also serves to fix an unfolded awning 400 immobile from the effect of the wind.

The raising and lowering rods 300 are provided in the horizontal direction, and provided with, at each of the left and right end portions of the raising and lowering rods 300, wire-passing holes 310 through which the guide wires 200 pass such that the raising and lowering rods are raised and lowered along the guide wires 200.

The number of the raising and lowering rods 300 can be appropriately determined in consideration of a size and a height of the building.

The cable 110 of the winch 100 can be connected to the uppermost or lowermost raising and lowering rod 300 among the raising and lowering rods 300, wherein when the winch 100 is provided on the ground as shown in FIG. 1, the cable 110 is connected to the uppermost raising and lowering rod 300, and when the winch 100 is provided on the rooftop of the high-rise building as shown in FIG. 2, the cable 110 is connected to the lowermost raising and lowering rod 300. Here, when the cable 110 is connected to the lowermost raising and lowering rod 300, of course, the uppermost raising and lowering rod 300 must be fixed to the guide wires 200 at the upper story of the building as shown in FIG. 2 and should not move along the guide wires 200. This is because when the uppermost raising and lowering rod 300 lowers along the guide wires 200, the awning 400 cannot be unfolded as shown in FIG. 2.

In other words, in FIG. 1, the awning 400 is unfolded while the raising and lowering rods 300 rises, and in FIG. 2, the awning 400 is unfolded while the raising and lowering rods 300 lowers.

With the awning 400 unfolded, a distance between the raising and lowering rods 300 can be designed to be approximately 1 meter to 3 meters.

The awning 400 is coupled to the raising and lowering rods 300, and unfolded so as to block the sunlight when the raising and lowering rods 300 are spaced apart from each other while being raised or lowered.

A guide pulley 120 serves to guide raising and lowering of the cable 110 while being rotated by engaging with the cable 110 which is released from or wound up to the winch 100. The cable 110 can be raised or lowered stably along a predetermined path by the guide pulley 120.

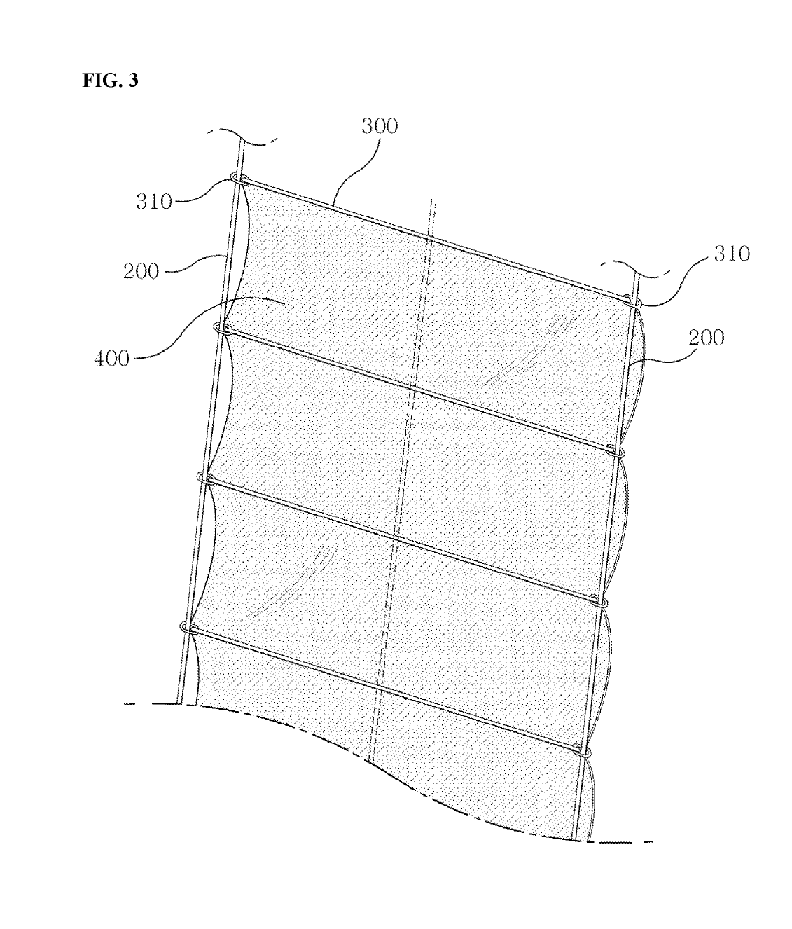

FIG. 3 shows a specific embodiment of the awning 400, wherein the upper and lower portions of the awning 400 are attached to the raising and lowering rods 300, respectively, and the awning 400 is unfolded sequentially as the raising and lowering rods 300 rise or lower, and a distance between the raising and lowering rods 300 is determined by a distance between the upper portion and the lower portion of the awning 400.

Materials of the awning 400 can be selected from various materials, such as general tent materials, translucent netting materials considering a view, natural materials and so on. It is preferable to select a material which can suppress damage or aging caused by sunlight or rainwater etc. to the utmost and has a sufficient strength and durability.

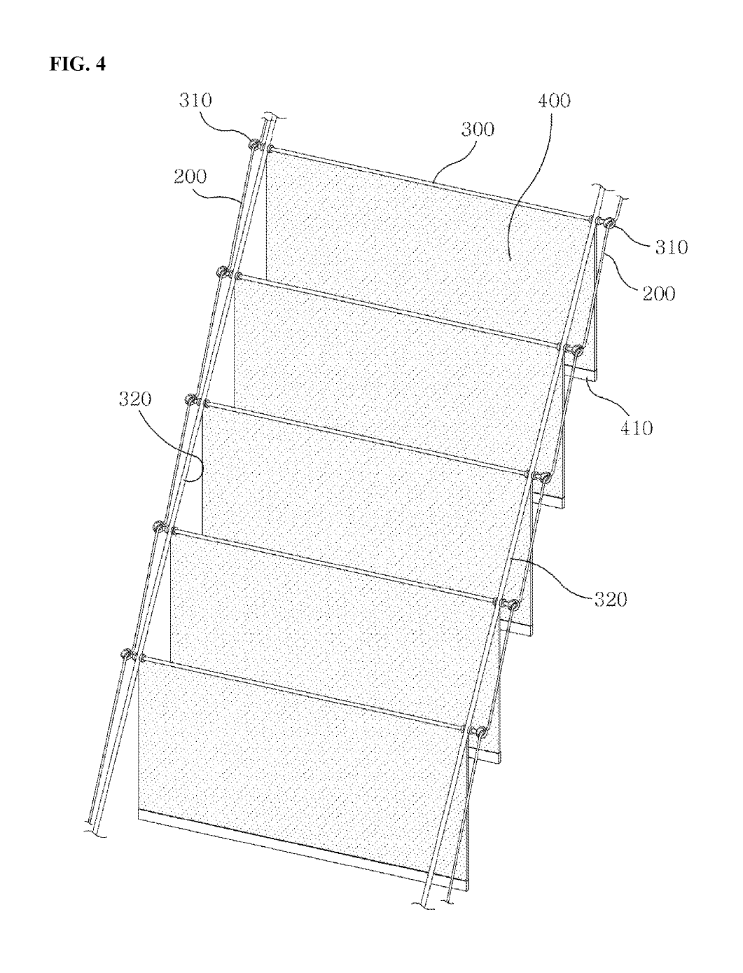

FIG. 4 shows another embodiment of the awning 400, wherein only the upper portion of the awning 400 is attached to the raising and lowering rods 300 and the awning is unfolded sequentially in a suspended state, and a weight member 410 is attached to the lower portion of each awning 400 to weight the awnings 400 and keep it unfolded. In other words, one raising and lowering rod 300 is attached to one awning 400, and each awning 400 keeps a naturally unfolded state without fluttering due to a weight of the weight member 410.

The weight members 410 can be made of a variety of materials, and its shape and structure are not particularly limited. The weight members are attached to the lower ends of the awnings 400 and prevent the awnings 400 from fluttering due to a proper weight.

In addition, connecting cables 320 interconnect the raising and lowering rods 300 to determine a distance between the raising and lowering rods 300 when the distance between the raising and lowering rods 300 increases as the raising and lowering rods 300 ascend or descend.

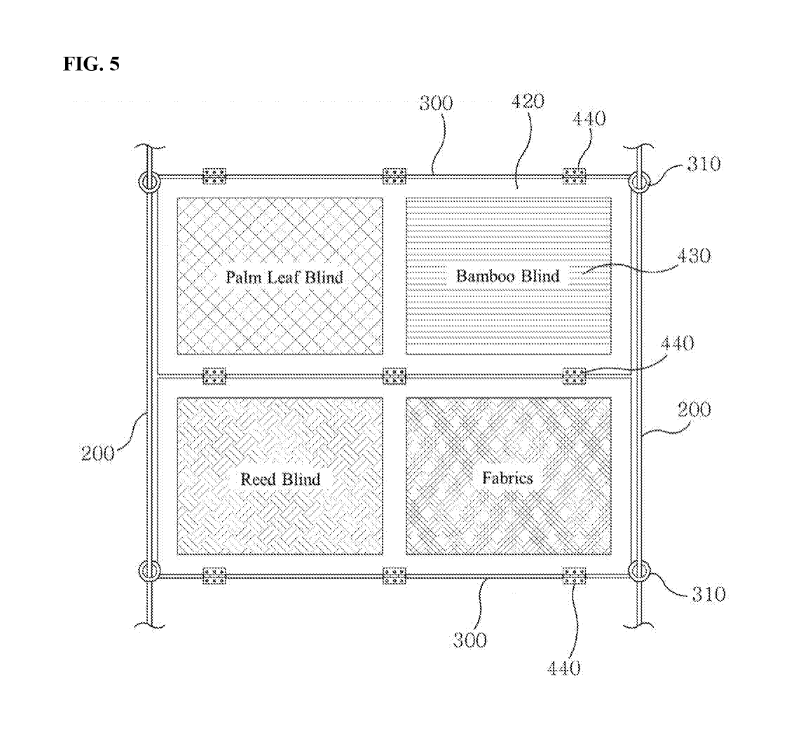

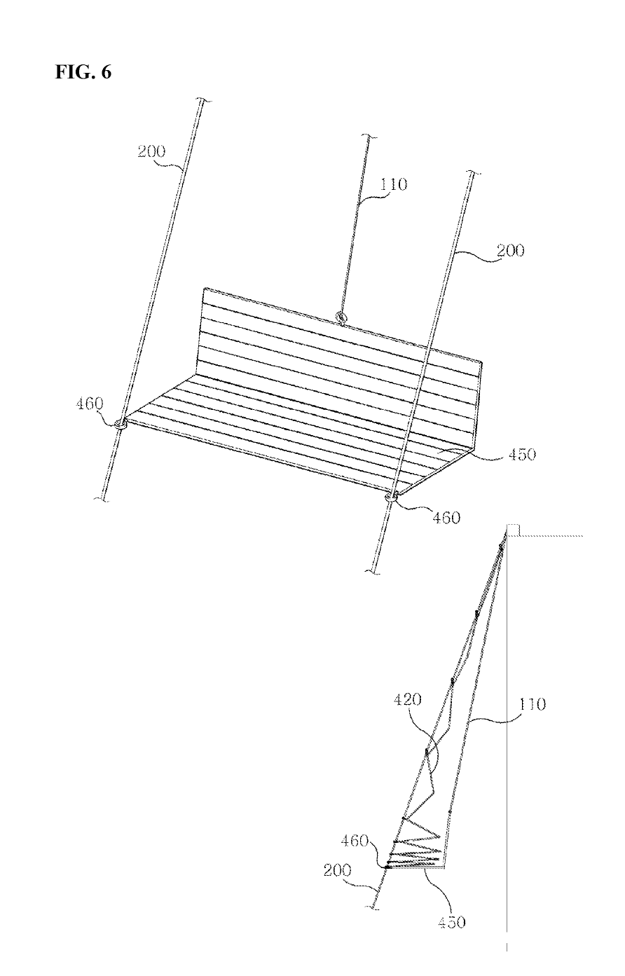

FIGS. 5 and 6 show another specific embodiment of the awning 400.

A panel frame 420 is composed of two panels coupled by hinges 440 to rotate and move. Blind portions 430 are provided at central incision portions of the panel frame 420 so as to block the sunlight and see the outside.

The blind portions 430 can be a blind made of bamboos, palm leaves, reeds, or fabrics. The blind portions can effectively prevent the sunlight from entering and make it possible to see the outside through a gap of the blind, thereby providing blocking the sunlight and seeing the outside at the same time.

An upper portion of an upper panel of the panel frame 420 is coupled to a lower portion of a lower panel of a neighboring panel frame 420 by the hinges 440 to rotate and move at the raising and lowering rod 300 located at the upper portion of the upper panel. A lower portion of a lower panel of the panel frame 420 is coupled to an upper portion of an upper panel of a neighboring panel frame 420 by the hinges 440 to rotate and move at the raising and lowering rod 300 located at the lower portion of the lower panel.

The panel frames 420 are also overlapped or unfolded by the cable 110 of the winch 100. FIG. 6 shows a case where the panel frames 420 constituting the awning 400 are overlapped and received on a panel holder 450 when the panel holder 450 is raised by the cable 110. In other words, the cable 110 is not directly connected to the raising and lowering rods 300 but is connected to the panel holder 450 as shown in FIG. 6. Also in this case, of course, the uppermost raising and lowering rod 300 should be fixed to the guide wires 200 at the upper story of the building as shown in FIG. 6 and should not move along the guide wires 200. This is because when the uppermost raising and lowering rod 300 descends along the guide wires 200, the awning 400 cannot keep an unfolded state.

The panel holder 450 is provided at a bottom of the lowermost raising and lowering rod 300, provided with, on both sides thereof, rings 460 through which the guide wires 200 passes, and is connected to the cable 110 of the winch 100 to ascend and descend.

A sensor 510 detects a length of the cable 110 that is released from or wound up to the winch 100, and various types of sensors can be selected. In some cases, a sensor that senses the number of revolutions of the guide pulley 120 and calculates a distance of the cable 110 passing through the guide pulley 120 may be used.

A controller 520 receives a sensing signal from the sensor 510 or receives an input signal instructing an operation of the winch 100 to control the operation of the winch 100. When a plurality of winches 100 is provided in one building, it is also possible for the controller to integrate and control them.

A housing 600 is provided on the upper story, the rooftop, or the ground of the high-rise building, and serves as a receptacle for accommodating the awning 400 when being folded. The housing 600 is generally provided in the same location as the winch 100.

Although specific embodiments of the present invention have been described with reference to the accompanying drawings as above, it is to be understood that the scope of protection of the present invention is not necessarily limited to such embodiments, but various design modifications, additions and deletions of known techniques, simple numerical limitations etc. within the scope which does not change the teaching of the invention are included in the scope of protection of the present invention.

### REFERENCE NUMERALS OF DRAWINGS

100: winch

110: cable

120: guide pulley

200: guide wire

300: raising and lowering rod

310: wire-passing hole

320: connecting cable

400: awning

410: weight member

420: panel frame

430: blind portion

440: hinge

450: panel holder

460: ring

510: sensor

520: controller

600: housing

1. A large-sized external awning system for high-rise buildings, the system comprising:
a winch (100) provided at an upper story, a rooftop or a ground of a high-rise building, and releasing or winding up a cable (110);
two guide wires (200) connected to a lower story or a ground of the high-rise building from an upper story or a rooftop of the high-rise building, and spaced apart at a predetermined distance to be provided in parallel;
a plurality of raising and lowering rods (300) provided in a horizontal direction, and provided with, at each of the left and right end portions thereof, wire-passing holes (310) through which the guide wires (200) pass such that the raising and lowering rods are raised and lowered along the guide wires (200); and
an awning (400) coupled to the raising and lowering rods (300) and unfolded so as to block the sunlight when the raising and lowering rods (300) are spaced apart from each other while being raised or lowered,
wherein the cable (110) of the winch (100) winds up or release the uppermost or lowermost raising and lowering rod (300) among the raising and lowering rods (300), and
wherein when the cable (110) of the winch (100) winds up the lowermost raising and lowering rod (300) among the raising and lowering rods (300), the uppermost raising and lowering rod (300) is fixed to the guide wire (200) at the upper story of the high-rise building.

2. The system of claim 1, further comprising a guide pulley (120) guiding raising and lowering of the cable (110) while being rotated by engaging with the cable (110) which is released from the winch (100).

3. The system of claim 1, wherein an upper portion and a lower portion of the awning (400) are attached to the raising and lowering rods (300), and the awning is unfolded as the raising and lowering rods (300) rise or lower, thereby determining a distance between the raising and lowering rods (300).

4. The system of claim 1, wherein an upper portion of the awning (400) is attached to the raising and lowering rods (300), allowing the awning to be unfolded in a suspended state, and a weight member (410) is attached to a lower end of the awning (400) to weight the awning (400) and keep it unfolded,
wherein the raising and lowering rods (300) further comprises connecting cables (320) interconnecting the raising and lowering rods (300) to determine a distance between the raising and lowering rods (300) when the distance between the raising and lowering rods (300) increases as the raising and lowering rods (300) ascend or descend.

5. A large-sized external awning system for high-rise buildings, the system comprising:
a winch (100) provided at an upper story, a rooftop or a ground of a high-rise building, and releasing or winding up a cable (110);
two guide wires (200) connected to a lower story or a ground of the high-rise building from an upper story or a rooftop of the high-rise building, and spaced apart at a predetermined distance to be provided in parallel;
a plurality of raising and lowering rods (300) provided in a horizontal direction, and provided with, at each of the left and right end portions thereof, wire-passing holes (310) through which the guide wires (200) pass such that the raising and lowering rods are raised and lowered along the guide wires (200); and
an awning (400) coupled to the raising and lowering rods (300) and unfolded so as to block the sunlight when the raising and lowering rods (300) are spaced apart from each other while being raised or lowered,
wherein the uppermost raising and lowering rod (300) is fixed to the guide wire (200) at an upper story of the high-rise building,
wherein the awning (400) comprises a panel frame (420) including two panels coupled by hinges (440) to rotate and move, and blind portions (430) provided at central incision portions of the panel frame (420) so as to block the sunlight and see the outside,
wherein an upper portion of an upper panel of the panel frame (420) is coupled to a lower portion of a lower panel of a neighboring panel frame (420) by the hinges (440) to rotate and move at the raising and lowering rod (300), wherein a lower portion of a lower panel of the panel frame (420) is coupled to an upper portion of an upper panel of a neighboring panel frame (420) by the hinges (440) to rotate and move at the raising and lowering rod (300),
wherein the system further comprises a panel holder (450) provided at a bottom portion of the lowermost raising and lowering rod (300), provided with, on both left and right sides thereof, rings (460) through which the guide wires (200) pass, connected to the cable (110) of the winch (100) to ascend and descend, and storing the panel frame (420) which is folded upon being raised.

6. The system of claim 1, further comprising:
a sensor (510) detecting a length of the cable (110) that is released from or wound up to the winch (100); and
a controller (520) receiving a sensing signal from the sensor (510) and controlling an operation of the winch (100).

7. The system of claim 6, further comprising a housing (600) provided on an upper story, a rooftop, or a ground of the high-rise building and serving as a receptacle accommodating the awning (400) when being folded.

8. The system of claim 2, further comprising:
a sensor (510) detecting a length of the cable (110) that is released from or wound up to the winch (100); and
a controller (520) receiving a sensing signal from the sensor (510) and controlling an operation of the winch (100).

9. The system of claim 3, further comprising:
a sensor (510) detecting a length of the cable (110) that is released from or wound up to the winch (100); and
a controller (520) receiving a sensing signal from the sensor (510) and controlling an operation of the winch (100).

10. The system of claim 4, further comprising:
a sensor (510) detecting a length of the cable (110) that is released from or wound up to the winch (100); and
a controller (520) receiving a sensing signal from the sensor (510) and controlling an operation of the winch (100).

11. The system of claim 5, further comprising:
a sensor (510) detecting a length of the cable (110) that is released from or wound up to the winch (100); and
a controller (520) receiving a sensing signal from the sensor (510) and controlling an operation of the winch (100).

12. The system of claim 8, further comprising a housing (600) provided on an upper story, a rooftop, or a ground of the high-rise building and serving as a receptacle accommodating the awning (400) when being folded.

13. The system of claim 9, further comprising a housing (600) provided on an upper story, a rooftop, or a ground of the high-rise building and serving as a receptacle accommodating the awning (400) when being folded.

14. The system of claim 10, further comprising a housing (600) provided on an upper story, a rooftop, or a ground of the high-rise building and serving as a receptacle accommodating the awning (400) when being folded.

15. The system of claim 11, further comprising a housing (600) provided on an upper story, a rooftop, or a ground of the high-rise building and serving as a receptacle accommodating the awning (400) when being folded.
